(19) United States
(12) Patent Application Publication
(10) Pub. No.: US 2011/0070503 A1
(43) Pub. Date: Mar. 24, 2011

(54) Solid Electrolyte, Fabrication Method Thereof and Thin Film Battery Comprising the Same

(75) Inventors: Sangcheol Nam, Seoul (KR); Hoyoung Park, Seoul (KR); Youngchang Lim, Seoul (KR); Kichang Lee, Seoul (KR); Geunwan An, Suwon-si (KR); Giback Park, Bucheon-si (KR); Hosung Hwang, Yongin-si (KR); Jimin Kim, Seoul (KR)

(73) Assignee: GSNANO TECH CO., LTD., Seoul (KR)

(21) Appl. No.: 12/993,820

(22) PCT Filed: Aug. 25, 2008
(86) PCT No.: PCT/KR2008/004942

§ 371 Date: Nov. 19, 2010

(30) Foreign Application Priority Data
May 21, 2008 (KR) 10-2008-0047297

(51) Int. Cl. H01M 10/0562; H01M 10/04

(52) U.S. Cl. 429/322; 427/126.1

(57) ABSTRACT

The present invention relates to a solid electrolyte enables high ion conductivity, excellent voltage stability, low electric conductivity, homogeneous composition, reduced self-discharge and excellent atmosphere stability, a method of producing the same and a thin film battery comprising the same. The solid electrolyte according to the present invention is represented by the following formula.

Liₓ—B—O_{y}—N_{z} <Formula>

### TECHNICAL FIELD

The present invention relates to a solid electrolyte, a method of producing the same, and a thin film battery comprising the same. More specifically, the present invention relates to a solid electrolyte that is represented by Liₓ-B-O_{y}—N_{z}, a method of producing the same, and a thin film battery comprising the same.

### BACKGROUND ART

In accordance with the development of electronic and information communication industries, one carries personal terminals and office devices, etc. Thereby, in many technical fields such as cell phones, portable AV devices, and portable OA devices, the miniaturization of the devices is rapidly accomplished. However, as compared to the miniaturization and the portable trend of electronic devices, the size of electric power source is not relatively largely reduced. Accordingly, it is required that the energy density is increased to develop the lithium secondary battery having the excellent performance and the small size.

Meanwhile, as the conventionally commercialized lithium secondary battery, it basically consists of an active material, a separation film, a liquid electrolyte, and a carbon anode. Since this structure is complicated, there is a limit in miniaturization. The conventional lithium secondary battery has some problems, in that it is not easy to produce the battery in a thin thickness because of the use of pouch and there is a possibility of explosion. In addition, the liquid electrolyte has some problems, in that it is frozen at low temperature, and is the evaporated at high temperature. Furthermore, the devices may be taken damages by the liquid leakage.

In order to overcome these problems, the thin film battery is developed. The thin film battery consists of a cathode, a solid electrolyte and an anode. The thin film battery is produced by sequentially forming films of constituents in all-solid state. Since the thin film battery may be produced in a thickness of a few tens of micrometers, the miniaturization can be accomplished. The thin film battery does not have the possibility of explosion unlike the conventional lithium secondary battery and is stable. In addition, according to the type of mask, various patterns of batteries can be made. The solid electrolyte used in the thin film battery should satisfy all the characteristics such as high ionic conductivity, electrochemical stability window, and low electrical conductivity. The solid electrolyte can solve some problems freezing at low temperature, vaporization at high temperature in the liquid electrolyte.

Meanwhile, the solid electrolyte may be classified into oxides and nonoxides according to the material, and classified into crystallines and glassy types according to the structure. A portion of the oxide-based electrolyte may show the hygroscopic property with moisture, but most of the oxide-based electrolyte is stable under an atmosphere. In addition, the oxide-based electrolyte has an easy manufacturing process, relatively high decomposition voltage, and easy formation of the thin film. However, the ion conductivity is in the range of 10⁻⁹ to 10⁻⁷ S/cm, which is relatively low as compared to the other electrolytes. The nonoxide-based electrolyte has the ion conductivity in the range of 10⁻⁵ to 10⁻³ S/cm, which is relatively high as compared to the other electrolytes. However, it is reacted with moisture under the atmosphere, its treatment is not easy, it is difficult to form the thin film, and the decomposition voltage is relatively low. The crystalline-based electrolyte has the ion conductivity in the range of 10⁻⁵ to 10⁻³ S/cm, which is relatively high as compared to the other electrolytes. However, heat treatment process at high temperature is required for the crystallization, and there is a high possibility of the occurrence of electron conduction due to the reduction of the transition metal. In addition, there is a limit in the main use thereof in the battery for high temperature operation. The amorphous-based electrolyte has the excellent isotropic conductivity, it is easy to obtain the thin film having the high density, and the grain boundary is not formed. In addition, as compared to the crystalline-based electrolyte having only the specific composition, since it is possible to continuously control the composition, it is possible to obtain the optimum ion conductivity according to a change in the composition. When the amorphous-based electrolyte is produced into a bulk type of glassy pellet, it is relatively difficult to uniformly control the composition as compared to the other electrolytes. However, when the thin film is grown by sputtering of oxide target, it can be easily obtained the glassy. In addition, it is possible to uniformly control the composition in the unit film. Because of the characteristics according to above-referenced type of the solid electrolyte, it is considered that it is preferable to adopt the solid electrolyte satisfying all the characteristics of the oxide and the glassy thin film batteries. However, the solid electrolyte is still pointed out as problems in the reactivity with lithium, the atmosphere stability and the low ion conductivity.

To significantly improve these problems is a Li_{3.3}PO_{3.8}N_{0.22} (LiPON) electrolyte (U.S. Pat. Nos. 5,338,625 and 5,597,660) that is reported by the John B. Bates group of Oak Ridge National laboratory of the US. The electrolyte is produced by the high radio frequency (RF) sputtering targeting on Li₃PO₄ under the nitrogen atmosphere. It is reported that since the electrolyte is very stable at interface between an anode and a cathode, the degradation of the battery is very small in use and most conditions required in the solid electrolyte for thin film battery are satisfied.

However, the LiPON electrolyte has a disadvantage, in that since the electronegativity of P as a constituent is high, the mobility of the Li ion is limited. In addition, since the phosphorus (P) element in LiPON may have −3, +1 and +5 valent oxidation states, the electrolyte shows the electronic conductivity of each of metal, semiconductor, and nonconductor. Accordingly, when the charging and discharging are repeated or the high charging electric potential state at an about decomposition voltage is maintained, the possibility of degradation of the LiPON electrolyte is gradually increased. Accordingly, there is a disadvantage that the electronic conductivity occurs, thus causing the self-discharge phenomenon by the micro short.

### DISCLOSURE

### Technical Problem

An object of the present invention is to provide a solid electrolyte that enables high ion conductivity, excellent voltage stability, low electric conductivity, the homogeneous composition, reduced self-discharge and excellent atmosphere stability. In addition, another object of the present invention is to provide a solid electrolyte that does not react with lithium.

Another object of the present invention is to provide a method of producing a solid electrolyte, in which the composition of constituents is easily controlled.

Another object of the present invention is to provide a thin film battery that enables stability while being charged and high efficiency in its discharging characteristic.

### Technical Solution

In order to accomplish the objects, the present invention provides a solid electrolyte that is represented by the following formula:

Liₓ-B-O_{y}—N_{z} <Formula>

wherein 1.1<x<3.6, 0.6<y<3.1, 0.5<z<1, and 2.2<x+y+z<7.7 are in the formula.

The present invention provides a method of producing a solid electrolyte, providing a target comprising Li, B, and O; and depositing the target on a substrate under an atmosphere comprising nitrogen by using a vacuum deposition to form the solid electrolyte represented by the formula.

The present invention provides a thin film battery comprising: a substrate; a cathode current collector that is positioned on the substrate; a cathode that is positioned on the cathode current collector; a solid electrolyte that is positioned on the cathode and is represented by the formula; an anode current collector that is electrically insulated with the cathode current collector; and an anode that is positioned on the anode current collector.

### ADVANTAGEOUS EFFECTS

A solid electrolyte according to the present invention enables high ion conductivity, voltage stability, low electric conductivity, homogeneous composition, reduced self-discharge and excellent atmosphere stability. The solid electrolyte according to the present invention has little reactivity with lithium. In a method of producing a solid electrolyte according to the present invention, the composition of constituents of the solid electrolyte is easily controlled. In addition, a thin film battery comprising the solid electrolyte according to the present invention enables stability while being charged and high efficiency in its discharging characteristic.

### DESCRIPTION OF DRAWINGS

FIG. 1 is a graph that illustrates the XRD analysis results of Example 1;

FIG. 2 is a graph that illustrates the XRD analysis results of Comparative Example 1;

FIG. 3 is a graph that illustrates the XRD analysis results of Comparative Example 2;

FIG. 4 is a SEM image that illustrates a cross-section of Example 1;

FIG. 5 is a SEM image that illustrates a surface of Example 1;

FIG. 6 is a graph that illustrates the electrochemical impedance results of Example 1;

FIG. 7 is a graph that illustrates the electrochemical impedance results of Comparative Example 1;

FIG. 8 is a graph that illustrates the electrochemical impedance results of Comparative Example 2;

FIG. 9 is an Arrhenius graph in respect to the ion conductivity according to the temperature of Example 1;

FIG. 10 is a graph that illustrates the current change amount and the voltage according to the voltage of Example 1 and Comparative Example 1;

FIG. 11 is a graph that illustrates the high rate discharge characteristic results of Example 2;

FIG. 12 is a graph that illustrates the high rate discharge characteristic results of Comparative Example 3;

FIG. 13 is a SEM image that illustrates a cross-section of Example 2;

FIG. 14 is an age change discharge graph of Example 2; and

FIG. 15 is an age change discharge graph of Comparative Example 3.

### BEST MODE

Hereinafter, the present invention will be described in details.

I. Solid Electrolyte

A solid electrolyte according to the present invention is represented by the following formula:

Liₓ-B-O_{y}—N_{z} <Formula>

The electronegativity value of B (Pauling's scale: 2.0) comprised in the solid electrolyte according to the present invention is smaller than P (Pauling's scale: 2.1) comprised in the conventional solid electrolyte. Accordingly, as compared to the P—O or P—N bond in that the dipole moment is largely separated, the movement of Li⁺ in the B—O or B—N bond is smooth, thus the Li ion conductivity is high. Here, the ion conductivity of the electrolyte is represented by σ=neμ. n is a mole concentration of Li (composition), e is a constant as an elementary charge, and μ is the mobility of the Li ions, a function of molecular structure, and may be affected by the amount of Li and the substitution of N.

B that is comprised in the solid electrolyte according to the present invention has a +3 valent as single oxidation number. On the other hand, P that is comprised in the conventional solid electrolyte according to the present invention has three oxidation numbers of −3, +1, and +5. Because of the single oxidation number, the composition of B does not locally form different composition and structure like P during the production of the solid electrolyte. Accordingly, the solid electrolyte according to the present invention comprises B to realize the more homogeneous composition and excellent stability.

Since the solid electrolyte according to the present invention comprises only Li, B, O, and N, as compared to the conventional solid electrolyte comprising P or B and P, the composition of the solid electrolyte according to the present invention is homogeneous. In comparison with the solid electrolyte according to the present invention, the conventional solid electrolyte comprising B and P increases the possibility of occurrence of the leakage current. Since P is further comprised, the range of the electrochemical stability window is narrowed down, thus the self-discharge of the battery may be increased. In addition, when the solid electrolyte is produced by sputtering, five elements of Li, P, B, O, and N should be controlled during the production of the target and the deposition of the thin film. Therefore, it is difficult to adjust the optimum composition, and the process reproducibility is rapidly reduced.

1.1<x<3.6, 0.6<y<3.1, 0.5<z<1, and 2.2<x+y+z<7.7. If the mentioned range is satisfied, the ion conductivity is high, and the excellent characteristic is shown as the solid electrolyte. If the mentioned range is not satisfied, the ion conductivity is rapidly reduced, or because of the excessive amount of Li, the structure may be disintegrated and the moisture reactivity in the atmosphere may be increased. In the formula, it is preferable in the range of 2.5<x<3.5, and 2.5<y+z<4.0. If the mentioned range is satisfied, the ion conductivity of Li may show the highest value. In addition, since the values of y and z are increased in proportion to the amount of x, it may satisfy only the mentioned condition.

The solid electrolyte according to the present invention enables high ion conductivity, voltage stability, low electric conductivity, homogeneous composition, reduced self-discharge and excellent atmosphere stability. The solid electrolyte according to the present invention has little reactivity with lithium.

II. Production Method of the Solid Electrolyte

Hereinafter, the production method of the solid electrolyte according to an embodiment of the present invention will be described.

First, the lithium borate-based target comprising Li, B, and O is provided. The target is preferably any one selected from the group consisting of LiBO₂, Li₃BO₃, and Li₅BO₄. Here, it is preferable that the target is produced by the following method. First, the dry mixed powder comprising the boron oxide-based powder and the lithium carbonate-based powder is provided. At this time, it is preferable that the boron oxide-based powder is B₂O₃. It is preferable that the lithium carbonate-based powder is Li₂CO₃. The target composition of Li is adjusted by the amount of lithium carbonate (Li₂CO₃). Subsequently, the mixed powder is sintered at a temperature in the range of 500 to 700° C. for 30 min to 1.5 hours. While the sintering process is performed, CO₂ of the lithium carbonate-based powder is removed and only Li₂O is remained. After the sintering, the powder is produced by the dry mechanical working. Then the target is made from the powder and is bonded to the backing plate.

Subsequently, the vacuum deposition is performed under the atmosphere comprising nitrogen as the target. The atmosphere comprising nitrogen may be any one selected from the group consisting of atmospheres comprising 100% of nitrogen, nitrogen and oxygen, nitrogen and argon, and nitrogen, oxygen and argon. It is preferable that the vacuum deposition is any one selected from the group consisting of sputtering, ion plating, activated reactive evaporation (ARE), ion beam assisted deposition (IBAD), ionized cluster beam deposition (ICB), pulsed laser deposition (PLD) and arc source deposition. In the present invention, it is more preferable that the solid electrolyte is produced by the sputtering. It is preferable that the sputtering is the high radio frequency (RF) sputtering. In addition, if the solid electrolyte is produced by performing the sputtering, it is preferable that the power is in the range of 2.0 to 4.0 W/cm², and the process pressure is in the range of 3.0 to 15.0 mTorr. The condition is changeable by those who skilled in the related art, and is not limited thereto.

Thereby, the solid electrolyte represented by Liₓ-B—O_{y}—N_{z} is accomplished.

By producing the solid electrolyte according to the present invention under the nitrogen atmosphere by the sputtering, a portion of oxygen of the Li—B—O (lithium borate)-based substance as the target is substituted with nitrogen. Due to the nitrogen substitution, the electrostatic attraction is reduced to enable the movement of Li to be more smoothly. In addition, the ion conductivity of 100 times as high as the Li—B—O (lithium borate)-based substance can be obtained.

III. Thin Film Battery

Hereinafter, the thin film battery according to an embodiment of the present invention will be described.

A thin film battery according to the present invention comprising: a substrate; a cathode current collector that is positioned on the substrate; a cathode that is positioned on the cathode current collector; a solid electrolyte represented by Liₓ-B-O_{y}—N_{z} that is positioned on the cathode; an anode current collector that is electrically insulated with the cathode current collector; and an anode that is positioned on the anode current collector.

It is preferable that the substrate is any one selected from the group consisting of mica, Al₂O₃, Si wafer, SiO₂ wafer, glass, polymer film and metal. It is preferable that as the cathode current collector, a collector is generally used in the thin film battery. It is preferable that the cathode is any one selected from the group consisting of LiCoO₂, LiMn₂O₄, Li[Ni,Co,Mn]O₂ and LiFePO₄. The solid electrolyte is represented by in the formula, 1.1<x<3.6, 0.6<y<3.1, 0.5<z<1, and 2.2<x+y+z<7.7.

It is preferable that the solid electrolyte is positioned in a thickness of 0.7 to 3.0 μm in the thin film battery. If the thickness is smaller than the range, the short of battery may occur. If the thickness is larger than the range, the resistance of the battery is increased to reduce the performance of the battery. In addition, while the solid electrolyte is produced, the process time is long, and thus the mass productivity is reduced. The detailed description of the solid electrolyte will be omitted because it is described in the above. It is preferable that as the anode current collector, a collector is generally used in the thin film battery. It is preferable that the anode is any one selected from the group consisting of Li, C, graphite, metal oxide, nitrogen-based metal, silicide-based metal and a metal alloy thereof.

The thin film battery comprising the solid electrolyte according to the present invention is stable in a charging state and can result in the high efficiency discharge characteristics.

### MODE FOR INVENTION

A better understanding of the present invention may be obtained in light of the preferred examples which are set to forth to illustrate, but are not to be construed to limit the present invention.

### Example 1, Comparative Example 1 and Comparative Example 2

### Production of the Solid Electrolyte

The target disclosed in Table 1 was subjected to the RF magnetron sputtering method under 100% of nitrogen atmosphere by the power and the process pressure described in the following Table 1 to produce the solid electrolyte.

TABLE 1

| | | | | Final thickness |
|---|---|---|---|---|
| | | | Process | of solid |
| | | Power | pressure | electrolyte |
| | Target | (W/cm²) | (mTorr) | (μm) |
| Example 1 | Li₃BO₃ | 2.46 | 15.0 | 1.4 |
| Comparative | Li₃PO₄ | 2.46 | 4.1 | 1.4 |
| Example 1 | | | | |
| Comparative | LiBO₂ | 2.22 | 4.5 | 1.5 |
| Example 2 | | | | |

### Experimental Example 1

### Performance Test of the Solid Electrolyte

<Composition Analysis of the Solid Electrolyte>

The relative ratio of the compositions obtained by the ICP-AES/ERD-TOF analysis results of Example 1 and Comparative Example 2 are described in Table 2.

TABLE 2

| | | Comparative |
|---|---|---|
| | Example 1 | Example 2 |
| Li | 3.099 | 0.903 |
| B | 1.000 | 1.000 |
| O | 2.532 | 0.658 |
| N | 0.516 | 0.984 |
| Composition | 3.10:1.0:2.53:0.52 | 0.9:1.0:0.66:0.98 |
| (Li:B:O:N) | | |

<Structure Analysis>

(1) X-Ray Diffraction Analysis

Example 1, Comparative Example 1 and Comparative Example 2 were performed by using RINT/DMAS-2500 device under the following conditions.

X-ray: Cu Kα (λ=1.5406 Å)

Voltage-current: 40 V-30 mA

Measurement angle range: 15 to 80 Theta

Step: 0.02°

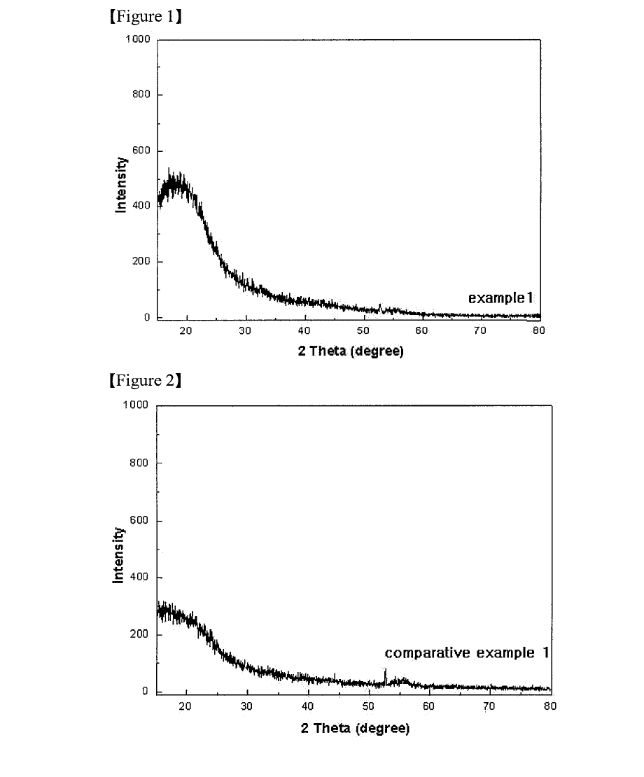

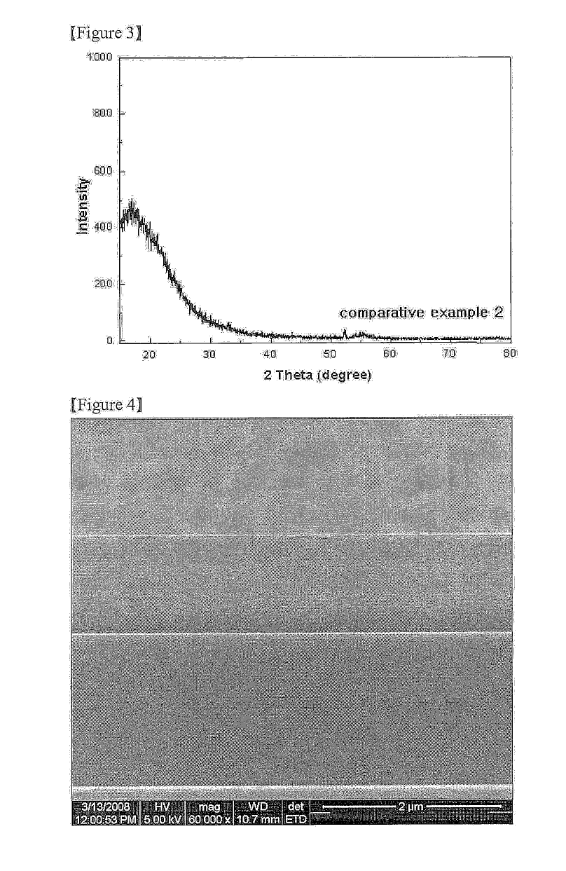

The X-ray diffraction (XRD) analysis results of Example 1, Comparative Example 1 and Comparative Example 2 are shown in FIGS. 1 to 3.

(2) SEM Image Analysis

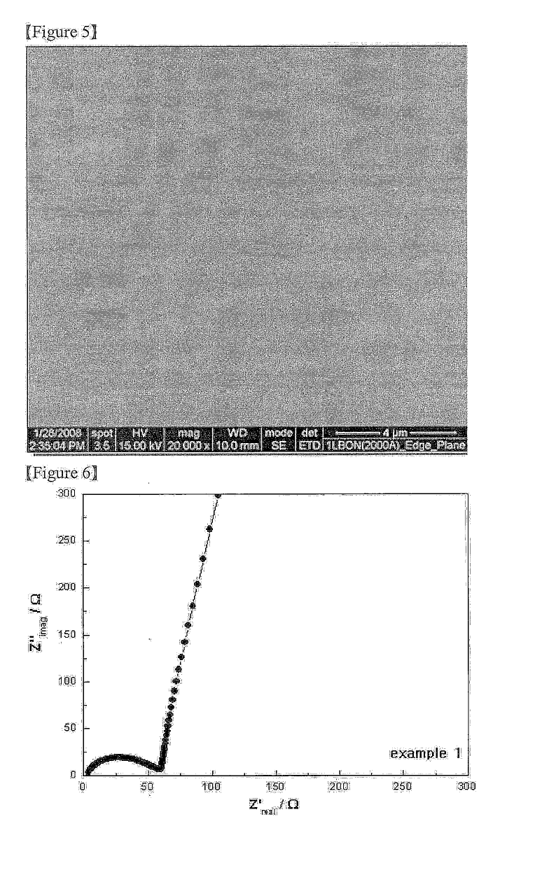

FIG. 4 is a SEM image illustrating a cross-section of Example 1, and FIG. 5 is a SEM image illustrating a surface of Example 1.

With reference to FIGS. 1 to 5, it can be seen that the solid electrolytes of Example 1, Comparative Example 1 and Comparative Example 2 are amorphous type of thin film not showing the crystallinity. The amorphous glass-based electrolyte can be more easily produced into a thin film as compared to the crystalline-based electrolyte. In addition, since the ion conductivity is continuously changed according to the composition, it is free to adjust the chemical composition of the thin film while the deposition is performed.

<Ion Conductivity and Resistance>

The ion conductivity and resistance measured of Example 1, Comparative Example 1 and Comparative Example 2 are shown in Table 3.

TABLE 3

| | ion conductivity | resistance |
|---|---|---|
| | (S/cm) | (Ω) |
| Example 1 | 2.3 × 10⁻⁶ | 61 |
| Comparative Example 1 | 1.2 × 10⁻⁶ | 120 |
| Comparative Example 2 | 4.3 × 10⁻⁹ | 35,083 |

With reference to Table 3, it can be seen that the ion conductivity and the resistance of Example 1 in the same area are better as compared to Comparative Example 1 and Comparative Example 2.

<Electrochemical Characteristic Analysis>

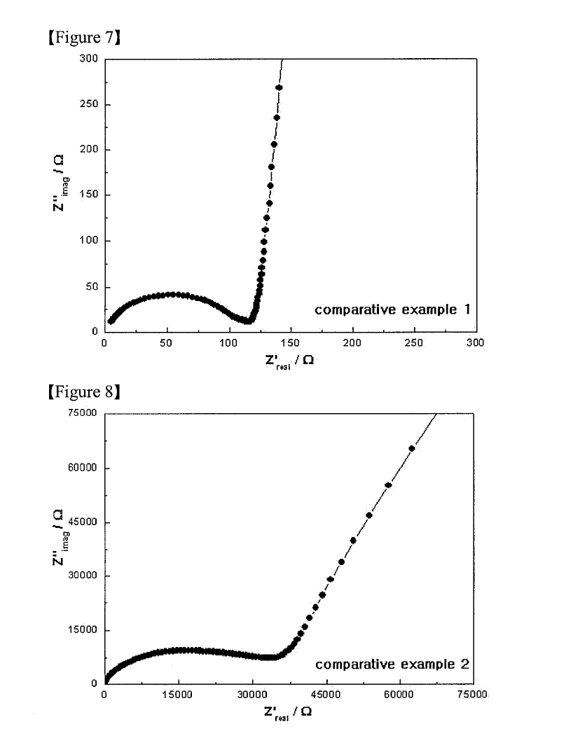

FIGS. 6 to 8 are graphs illustrating the electrochemical impedance results of Example 1, Comparative Example 1 and Comparative Example 2.

With reference to FIGS. 6 to 8, it can be seen that the resistance of Comparative Example 2 is the largest, the resistance of Comparative Example 1 is in the middle, and the resistance of Example 1 is the smallest. Accordingly, it can be seen that the ion conductivity of Example 1 is the most excellent.

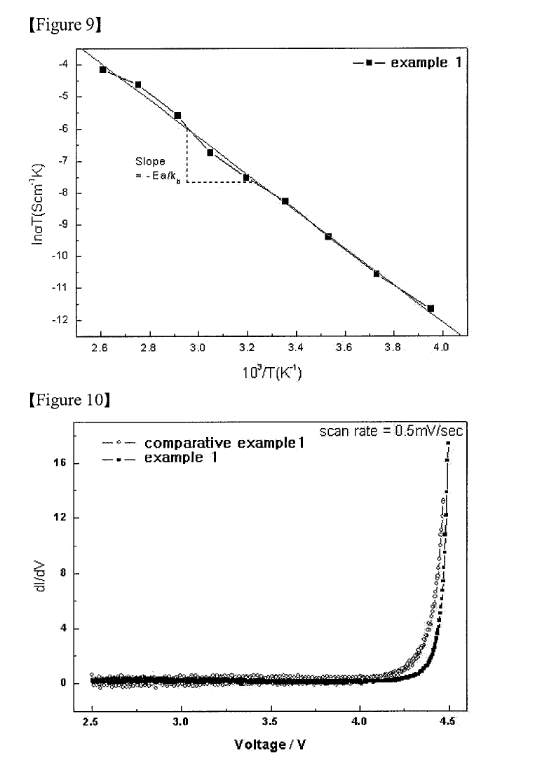

FIG. 9 is an Arrhenius graph in respect to the ion conductivity based on the impedance value according to the temperature within the temperature in the range of −20 to 110° C. in a blocking electrode structure (three-layer film structure: Pt/solid electrolyte/Pt) produced by using Example 1.

With reference to FIG. 9, the activation energy value of Example 1 is 0.49 eV. It can be seen that the value is substantially smaller than the activation energy of 0.56 eV of Comparative Example 1 (see U.S. Pat. No. 5,338,625). Thereby, it can be seen that the conduction of Li ion of Example 1 is very easily performed as compared to that of Li ion Comparative Example 1.

<Voltage Stability>

While the DC voltage of 0.5 mV/sec was applied to the upper and the lower Pt electrodes of the blocking electrode structure (three-layer film structure: Pt/solid electrolyte/Pt) each produced by using Example 1, and Comparative Example 1, the current values were measured thereto. The results are shown in FIG. 10. In FIG. 10, the y axis shows the current change amount according to the voltage and the x axis shows the voltage.

With reference to FIG. 10, the current change amount is rapidly increased at 4.0 V or more, and in the case of Example 1, the current change occurs at 4.3 V or more. On the other hand, in the case of Comparative Example 1, the increase is shown at about 4.1 V. Accordingly, it can be seen that the stability of Example 1 is high at the voltage of 4.0 V or more. From the results, it can be seen that in the case of the thin film battery according to the present invention, the electrochemical stability window is broader as compared to the thin film battery adopting the conventional solid electrolyte of the LiPON structure. In addition, since when the charge voltage of the thin film battery is 4.0 V or more, Example 1 is more stable than Comparative Example 1. Accordingly, it can be predicted that while the thin film battery is stored in a charge state, the self-discharge phenomenon is very small.

### Example 2

### Production of the Thin Film Battery

The platinum was formed on the Mica substrate having the thickness of 50 μm by using the cathode current collector by the DC sputtering in 2500 Å. Subsequently, after the cathode LiCoO₂ was formed by the RF sputtering in 1 μm, the heat treatment was performed at the high temperature of 600° C. or more. The solid electrolyte of Example 1 was formed on the heat-treated cathode in 1 μm. Nickel was formed using the DC sputtering in 2,500 Å by the anode current collector on the position electrically insulated with the cathode current collector. Li was formed in 2 μm on the structure by using the thermal evaporation vacuum deposition to prepare Example 2 of the thin film battery.

### Comparative Example 3

### Production of the Thin Film Battery

The platinum was formed on the Mica substrate having the thickness of 50 μm by using the cathode current collector by the DC sputtering in 2500 Å. Subsequently, after the cathode LiCoO₂ was formed by the RF sputtering in 1 μm, the heat treatment was performed at the high temperature of 600° C. or more. The solid electrolyte of Comparative Example 1 was formed on the heat-treated cathode in 1 μm. Nickel was formed using the DC sputtering in 2,500 Å by the anode current collector on the position electrically insulated with the cathode current collector. Li was formed in 2 μm on the structure by using the thermal evaporation vacuum deposition to prepare Comparative Example 3 of the thin film battery.

### Experimental Example 2

### Performance Test of the Thin Film Battery

<Discharge Characteristic>

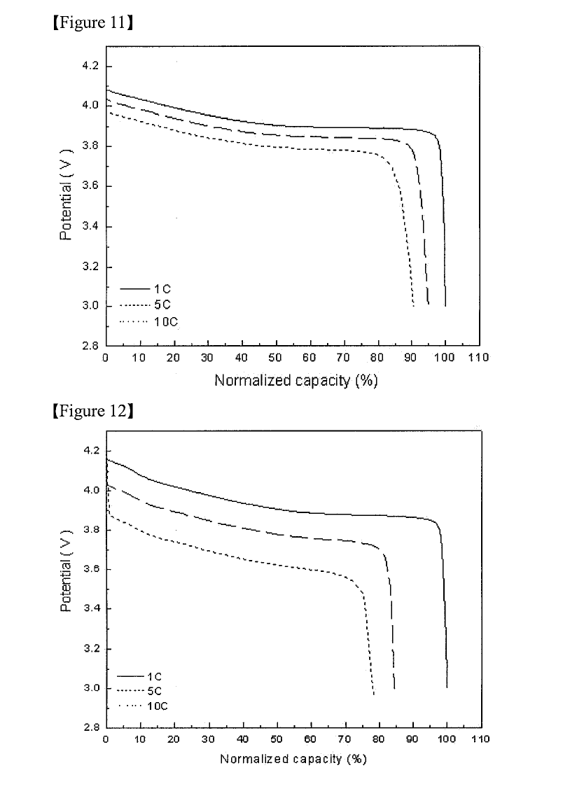

FIG. 11 is a graph illustrating discharge characteristic of Example 2, and FIG. 12 is a graph illustrating discharge characteristic of Comparative Example 3.

With reference to FIGS. 11 to 12, in Example 2, even though the discharging was performed by using 10 times of current amount to the maximum, the capacity of about 90% was shown. On the other hand, in Comparative Example 3, when the discharging was performed by using 10 times of current amount to the maximum, the capacity of about 78% was shown. Through the results, it can be seen that the high rate discharge characteristic of Example 2 is very excellent.

<Structure Analysis>

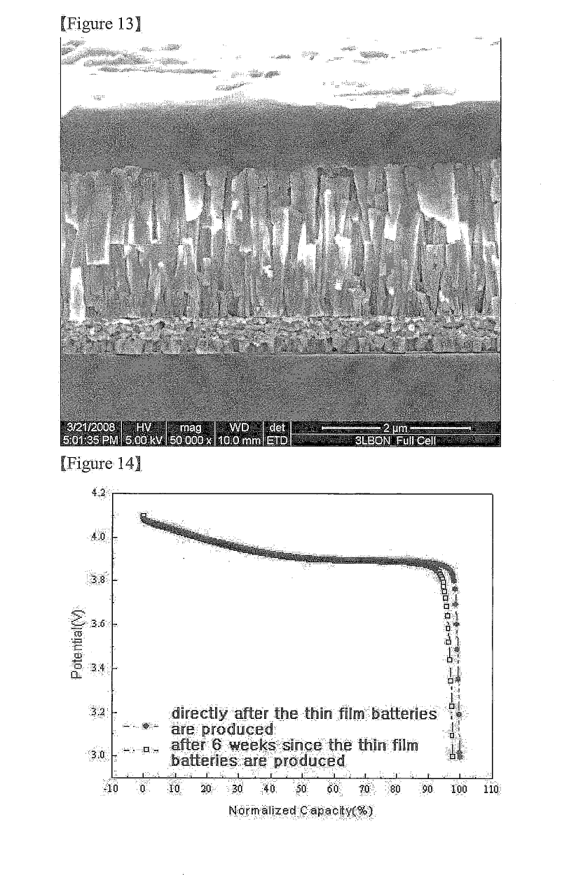

FIG. 13 is a SEM image illustrating a cross-section of the thin film battery of Example 2.

<Electrochemical Characteristic Analysis>

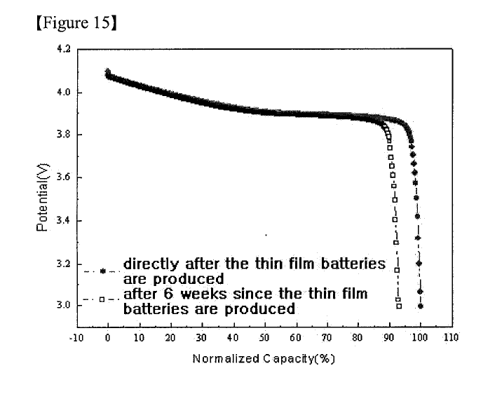

FIG. 14 is an age change discharge graph of Example 2, and FIG. 15 is an age change discharge graph of Comparative Example 3. To be more specific, FIGS. 14 and 15 are discharging capacity result graphs in respect to the test that directly after the thin film batteries of Example 2 and Comparative Example 3 are produced and after 6 weeks since the thin film batteries of Example 2 and Comparative Example 3 are produced, in the area of voltage in the range of 3.0 V to 4.1 V, electrostatic charging and discharging are performed. That is, FIGS. 14 and 15 compare, after the thin film batteries of Example 2 and Comparative Example 3 are produced, an initial discharging capacity and the discharging capacity after 6 weeks to each other.

With reference to FIGS. 14 to 15, the thin film battery of Example 2 maintained the capacity of 981 based on the conventional battery when the battery was stored in a charging state of 4.1 V for 6 weeks. On the other hand, the thin film battery of Comparative Example 3 maintained the capacity of 93% based on the conventional battery when the battery was stored in a charging state of 4.1 V for 6 weeks. Through these results, it can be seen that in views of the long-term stability, the Li—B—O—N-based electrolyte is very excellent in terms of the capacity maintaining characteristic at the high voltage.

1. A solid electrolyte represented by the following formula:
Liₓ-B-O_{y}—N_{z} <Formula>
wherein 1.1<x<3.6, 0.6<y<3.1, 0.5<z<1, and 2.2<x+y+z<7.7 are in the formula.

2. The solid electrolyte according to claim 1, wherein 2.5<x<3.5, and 2.5<y+z<4.0 are in the formula.

3. A method of producing a solid electrolyte, the method comprising:
providing a target comprising Li, B, and O;
depositing the target on a substrate under an atmosphere comprising nitrogen by using a vacuum deposition to form the solid electrolyte represented by the following formula:
Liₓ-B-O_{y}—N_{z} <Formula>
wherein 1.1<x<3.6, 0.6<y<3.1, 0.5<z<1, and 2.2<x+y+z<7.7 are in the formula.

4. The method according to claim 3, wherein the target is any one selected from the group consisting of LiBO₂, LiBO₃ and Li₅BO₄.

5. The method according to claim 4, wherein the target is produced by providing a mixed powder that comprises a boron oxide-based powder and a lithium carbonate-based powder, sintering the mixed powder at a temperature in the range of 500 to 700° C. for 30 min to 1.5 hour, and making the sintered mixed powder by a dry mechanical working.

6. The method according to claim 3, wherein the atmosphere comprising nitrogen is any one selected from the group consisting of atmospheres comprising 100% of nitrogen, nitrogen and oxygen, nitrogen and argon, and nitrogen, oxygen and argon.

7. The method according to claim 3, wherein the vacuum deposition is any one selected from the group consisting of sputtering, ion plating, activated reactive evaporation (ARE), ion beam assisted deposition (IBAD), ionized cluster beam deposition (ICB), pulsed laser deposition (PLD) and arc source deposition.

8. The method according to claim 7, wherein the sputtering is performed under the power in the range of 2.0 to 4.0 W/cm², and the process pressure in the range of 3.0 to 15.0 mTorr.

9. A thin film battery comprising:
a substrate;
a cathode current collector that is positioned on the substrate;
a cathode that is positioned on the cathode current collector;
a solid electrolyte that is positioned on the cathode and is represented by the following formula;
an anode current collector that is electrically insulated with the cathode current collector; and
an anode that is positioned on the anode current collector:
Liₓ-B-O_{y}—N_{z} <Formula>
wherein 1.1<x<3.6, 0.6<y<3.1, 0.5<z<1, and 2.2<x+y+z<7.7 are in the formula.

10. The thin film battery according to claim 9, wherein the substrate is any one selected from the group consisting of mica, Al₂O₃, Si wafer, SiO₂ wafer, glass, polymer film and metal.

11. The thin film battery according to claim 9, wherein the cathode is any one selected from the group consisting of LiCoO₂, LiMn₂O₄, Li[Ni,Co,Mn]O₂ and LiFePO₄.

12. The thin film battery according to claim 9, wherein a thickness of the solid electrolyte is in the range of 0.7 to 3.0 μm.

13. The thin film battery according to claim 9, wherein the anode is any one selected from the group consisting of Li, C, graphite, metal oxide, nitrogen-based metal, silicide-based metal and a metal alloy thereof.
